(19) United States
(12) Patent Application Publication
(10) Pub. No.: US 2013/0080188 A1
(43) Pub. Date: Mar. 28, 2013

(54) PERSONALIZED PHARMACY MEDICATION AND CARE MANAGEMENT SYSTEM

(71) Applicant: Lisa A. Rosenfeld, Boca Raton, FL (US)

(72) Inventor: Lisa A. Rosenfeld, Boca Raton, FL (US)

(21) Appl. No.: 13/586,508

(22) Filed: Aug. 15, 2012

Related U.S. Application Data
(60) Provisional application No. 61/540,233, filed on Sep. 28, 2011.

(51) Int. Cl. G06Q 50/22; G06Q 50/24

(52) U.S. Cl. 705/3; 705/2

(57) ABSTRACT

A medical information system. In one embodiment, the method includes the steps of issuing, by a clinician using a clinician computer, a prescription for a patient to a pharmacy computer; processing by the pharmacy computer at a pharmacy the prescription for the patient from the clinician; issuing a notice of prescription fulfillment by the pharmacy computer to a server, when the pharmacy issues a medication for the patient in response to the prescription received by the pharmacy computer; receiving the notice of prescription fulfillment by the server having a database; storing the prescription information in the database; and notifying the clinician computer if the medication has been picked up, delivered or abandoned by the patient or not renewed by the patient.

### RELATED APPLICATIONS

This application claims priority to U.S. Provisional Application 61/540,233 filed Sep. 28, 2011, which is herein incorporated by reference in its entirety.

### FIELD OF THE INVENTION

The invention relates generally to medical records management systems and specifically to electronic medical records management systems for prescriptions.

### BACKGROUND OF THE INVENTION

More than 3.9 billion prescriptions were written in the US in 2009, with the number increasing each year. Four out of five patients who visit a physician leave with at least one prescription. Medications are involved in 80% of all treatments and impact every aspect of a patient's life. However, according to the National Community Pharmacy Association, as many as three in four Americans say they do not take prescription medicines as directed.

As a result, drug therapy problems occur everyday and cost money; drug-related morbidity and mortality cost this country almost $290 billion annually, and exceed the amount spent on medications themselves. Further, the New England Healthcare Institute report found not taking medications as prescribed leads to poorer health, more frequent hospitalizations, a higher risk of death, and billions in increased medical costs each year. Estimates suggest that at least 30% of seniors take at least five prescription medications. Medicare patients with multiple chronic illnesses are estimated to see an average of 13 physicians, fill 50 different prescriptions per year, account for 76% of all hospital admissions and are 100 times more likely to have a preventable hospitalization than those with no chronic conditions. Additionally, people take over-the-counter (OTC) medications, nutritional and herbal supplements and vitamins, and these combinations with prescription medications could be harmful or fatal. It is estimated that 25% of all hospital admissions involving seniors are a result of medication problems, including prescription drug interactions.

Additionally, a 2009 study showed that the rate of unfilled prescriptions is increasing, from both denials and abandonment. Denials are prescriptions that have been submitted to a pharmacy but rejected by a patient's health plan and abandoned prescriptions are those that are submitted to a pharmacy but are never picked up. Both health plan denials and patient abandonment resulted in 14.4% of all new commercial plan prescriptions going unfilled in 2009, up 5.5% from 2008.

The United States population is aging and that demographic will have a significant impact on the healthcare industry. In 2011, 77 million baby boomers will begin to turn 65, and by 2025, 20% of the population will be seniors. Many will suffer from chronic medical conditions requiring a growing number of healthcare specialists to care for their medical needs and will result in an increasing number of medications and prescriptions, and increased demand for pharmacists. This will in turn exacerbate the issues discussed above.

The present invention will help reduce these issues.

### SUMMARY OF THE INVENTION

With the varied number of clinicians and specialists treating any given patient, the potential for serious drug therapy issues increases while the patient's comprehension of the role and purposes of their medications decreases, leading to poor medication adherence. This invention increases medication reconciliation by keeping prescriptions within one pharmacy system and through the use of innovative, accurate and timely medication data management linking the patient and clinicians throughout the healthcare delivery system. Additionally, the inclusion of Medication Therapy Management (MTM) and face-to-face consultations between the patient and pharmacist, and involving the clinician, has been shown to provide an effective intervention to improve medication adherence and reduce costly care by avoiding unnecessary emergency room visits, in-patient hospitalizations, serious illness and death.

The invention in one aspect relates to a medical information system. In one embodiment, the medical information system includes a pharmacy computer processing prescriptions for a pharmacy; a clinician computer for issuing, from a clinician, a prescription for a patient to a pharmacy computer; and a server having a database. In one embodiment, the server is in communication with the clinician computer and the pharmacy computer. In another embodiment, the pharmacy issues a medication for the patient in response to the prescription received by the pharmacy computer and issues a notice to the server that the prescription has been made available to the patient. In yet another embodiment, the server notifies the primary care clinician computer if the medication has been picked up (or delivered) to the patient as well as if the medication has been abandoned by the patient or not renewed by the patient.

In one embodiment, the system further includes a patient computer in communication with the server. In another embodiment, the system further comprises a registration/loyalty card that is issued by the system and assigned to the patient. In yet another embodiment, the database associates the clinician with the patient. In still yet another embodiment, the database associates the pharmacy with the patient. In one embodiment, the patient, using the patient computer, may access the database for the patient's medication record. In another embodiment, the server sends a reminder (via SMS text and voice message to a cellular phone) and via an email of abandoned or non-renewed prescriptions to the patient computer. In another embodiment, the server sends a notice of abandoned or non-renewed prescriptions to the prescribing clinician and to the primary clinician treating the registered patient. In still yet another embodiment, the patient may make a request of a human representative for the system using the patient computer.

In another aspect, the invention relates to a method of using a medical information system. In one embodiment, the method includes the steps of issuing, by a clinician using a clinician computer, a prescription for a patient to a pharmacy computer; processing by the pharmacy computer at a pharmacy the prescription for the patient from the clinician; storing the prescription information in the database by the server; issuing, by the pharmacy computer to a server, a notice that the prescription is available to the patient when the pharmacy issues a medication for the patient in response to the prescription received by the pharmacy computer; and, when the patient picks up the medication or has it delivered to them, issuing a notice, to the server, of prescription delivery; and notifying the primary clinician's computers of the receipt of the prescription by the patient, and if the medication has been abandoned by the patient or not renewed by the patient notifying the server and the prescribing and primary clinician's computers.

In one embodiment, the method further includes issuing a registration and/or loyalty card (registration/loyalty card) by the system and assigning it to the patient. In another embodiment, the method further includes associating the clinician with the patient in the database using the registration/loyalty card. In yet another embodiment, the method further includes associating the pharmacy with the patient in the database using the registration/loyalty card. In still yet another embodiment, the method further includes accessing the database for the patient's medication record using the patient computer. In one embodiment, the method includes sending a reminder of abandoned or non-renewed prescriptions to the patient computer and SMS text and voice message to the patient cellular telephone by the server. In yet another embodiment, the method includes making a request of a human representative for the system using the patient computer.

In another embodiment, the method includes the clinician requesting, via the server, a medication therapy management consultation for the registered patient by the pharmacy; and a notice of the outcome of such medication review is sent by the pharmacist to the clinician and server for the patient's medication record. In one embodiment, the patient can access the system for their own medication record, which includes notes from the medication therapy review session. In another embodiment, the patient can request a medication therapy management consultation through the server or human representative, and the results of such medication therapy consultation be transmitted to the primary care clinician's computer and to the patients' medication record.

In another aspect, the invention relates to a method of using a medical information system by all treating clinicians/HCPs of the enrolled patient, when providing medication samples from their office, transmitting such medication information to the server be included in the patient's medication record and notifying, by the server, the primary clinician treating the enrolled patient of the provision of medication. In another embodiment, the server is notified of vitamins, supplements and other medications provided by the clinician's office to the patient so as be included in the patient's medication record.

In another aspect, the invention relates to a method of using a medical information system. In another embodiment, the method further includes the steps of issuing, by a clinician, within a retail health clinic located within or affiliated with the designated pharmacy, a prescription for a patient to a pharmacy computer; processing by the pharmacy computer; issuing a notice of prescription availability by the pharmacy computer to a server; and issuing notification of the patient picking up or receiving the medication to the primary clinician and to the server having a database; and notifying the prescribing and primary clinician's computer of a medication abandoned by the patient or not renewed by the patient. In yet another embodiment, the method includes sending a notification of any immunization or vaccination provided to the enrolled patient at the pharmacy, or an affiliated retail health clinic, as recognized by the registration/loyalty card to the server, and then transmitted to the primary clinician's computer and the patient's medication record.

### BRIEF DESCRIPTION OF THE DRAWINGS

The objects and features of the invention can be understood more completely by referring to the drawings described below and the accompanying descriptions. In the drawings, like numerals are used to indicate like parts throughout the various views.

FIG. 1 is a highly schematic diagram of an embodiment of a system constructed in accordance with the invention; and

FIG. 2 is a flow diagram of an embodiment of actions performed by the system of FIG. 1.

### DESCRIPTION OF AN EMBODIMENT OF THE INVENTION

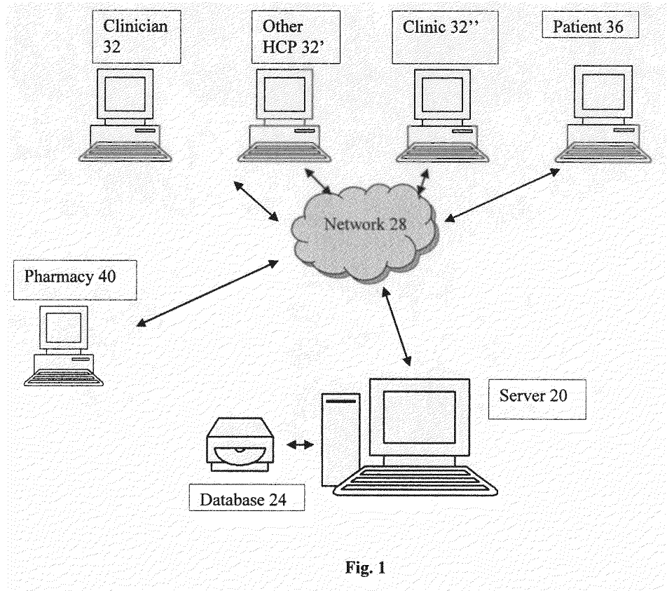

Referring to FIG. 1, in brief overview, an embodiment of a system constructed in accordance with the invention includes a server 20 in communication with a database 24 and in communication with the network 28. The server may be any form of processor including but not limited to a microprocessor, microcontroller, general purpose computer, programmable logic for use with a programmable logic device, (e.g. a Field Programmable Gate Array (FPGA) or other PLD), discrete components, integrated circuitry (e.g. an Application Specific Integrated Circuit (ASIC)), or any other means including any combination thereof. The server 20 executes software which permits the server 20 to communicate with the network 28 and with the database 24.

The software implementing all or part of the functionality previously described herein may be embodied in various forms, including, but in no way limited to, a source code form, a computer executable form, and various intermediate forms (e.g. forms generated by an assembler, compiler, linker, or locator). Source code may include a series of computer program instructions implemented in any of various programming languages (e.g. an object code, an assembly language, or a high-level language such as FORTRAN, C, C++, JAVA, or HTML) for use with various operating systems or operating environments. The source code may define and use various data structures and communication messages. The source code may be in a computer executable form (e.g. via an interpreter), or the source code may be converted (e.g. via a translator, assembler, or compiler) into a computer executable form.

The computer program may be fixed in any form (e.g. source code form, computer executable form, or an intermediate form) either permanently or transitorily in a tangible storage medium, such as a semiconductor memory device (e.g. a RAM, ROM, PROM, EEPROM, or Flash-Programmable RAM), a magnetic memory device (e.g. a diskette or fixed disk), an optical memory device (e.g. a CD-ROM), a PC card (e.g. PCMCIA card), or other memory device. The computer program may be fixed in any form in a signal that is transmittable to a computer using any of various communication technologies, including, but in no way limited to, analog technologies, digital technologies, optical technologies, wireless technologies (e.g. Bluetooth), networking technologies, and internetworking technologies. The computer program may be distributed in any form as a removable storage medium with accompanying printed or electronic documentation (e.g. shrink-wrapped software), preloaded with a computer system (e.g. on system ROM or fixed disk), or distributed from a server or electronic bulletin board over the communication system (e.g. the Internet or World Wide Web).

Various examples of suitable processing modules are discussed below in more detail. As used herein, a module refers to software, hardware, or firmware suitable for performing a specific data processing or data transmission task. Typically, in a preferred embodiment a module refers to a software routine, program, or other memory resident application suitable for receiving, transforming, routing and processing instructions, or various types of data such as OCT scan data, interferometer signal data, region of interest types, formulas, and other information of interest.

The database may be stored using any means for storing software or other instructions or data including, for example and without limitation, a hard disk, an optical disk, floppy disk, DVD (digital versatile disc), CD (compact disc), memory stick, flash memory, ROM (read only memory), RAM (random access memory), DRAM (dynamic random access memory), PROM (programmable ROM), EEPROM (extended erasable PROM), and/or other like computer-readable media.

Patients 36, clinicians 32, other HCP 32′, clinics 32″ (generally 32) and pharmacies (40) enrolled in the system are all in communication with the server 20 through the network 28. It should be noted that by network 28 is meant any system by which computers can communicate including but not limited to the world wide web, the internet, the telephone system and any other wide area or local area network using any form of fixed or mobile computer devices.

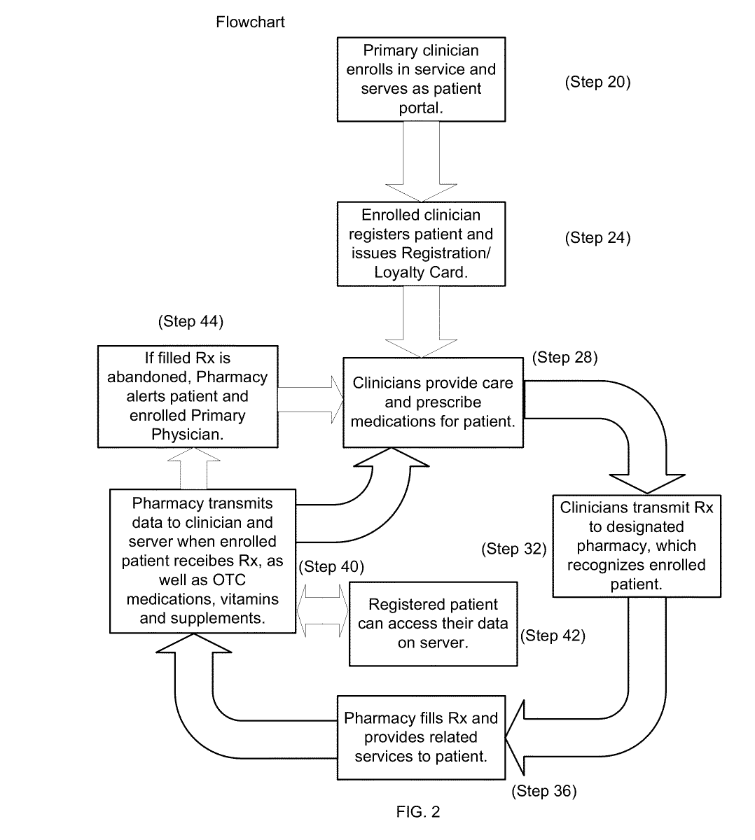

Referring to FIG. 2, again in overview, a primary clinician, or other Health Care Provider (HCP) (or his or her office) enrolls in the system and the clinician computer 32 acts as a portal into the system (Step 20). The clinician registers a patient associated with the clinician and the system issues the patient registration/loyalty card that may be password protected (Step 24) having an identification number. The patient can update or add additional information by way of a secure patient web page. The primary care clinician has access to the data on this web page. The clinician or clinicians (because there may be more than one health care provider associated with the patient) can then prescribe medications to the patient (Step 28) and issue the prescription to an enrolled pharmacy (Step 32) using the clinician 32 and pharmacy 40 computers. The pharmacy fills the prescription (step 36) and upon being presented with the registration/loyalty card information by the patient, transmits the information, indicating that the prescription has been filled, and picked up or delivered to the patient, to the server (Step 40). In an alternative embodiment the patient may present the number without the physical card in person, telephonically or over a network using a window on a website. A patient or his or her authorized representative may access the server to view their medical record (Step 42). If the prescription is not properly refilled or is abandoned, the server 20 notifies the patient, prescribing clinician and primary clinician (Step 44). Further the server can keep track of when a prescription for a chronic medical problem should be renewed and notify the patient computer 36 and the clinician computer 32 if the medication is not reordered or if it is not picked up and abandoned.

Looking at each of these steps individually:

The system first enrolls a clinician or other healthcare provider (HCP), into the system. In this application the terms clinician, physician and health care provider are used interchangeably. The system then registers patients of enrolled clinician into the system and issues a unique registration/loyalty card for each patient. The loyalty card may be physical such as a credit card form, smart card form or virtual form such as found in a smart phone or other mobile device. The clinician then treats the patient in the normal course and electronically prescribes a medication (or handwrites a prescription for a medication) for the enrolled patient to a pharmacy also registered with the system.

The registered pharmacy recognizes the clinician and/or the registered patient, performs the usual medication safety and reconciliation checks for the prescription. If necessary the registered pharmacy performs the usual contacts with prescribing clinician for any changes necessary as a result of reconciliation or formulary coverage. The registered pharmacy computer 40 or staff then notifies the patient for a pick-up or delivery option.

At the point of sale (POS) location at the registered pharmacy check-out the patient shows his or her registration/loyalty card which is read by the register scanner or card reader. In an alternative embodiment even at a POS location, the patient may simply state his or her registration number and key it or have a store employee key it into a POS register. The filled prescription information and any purchased over-the-counter medications, vitamins and supplements are transmitted to the server 20 by the pharmacy computer 40 which uses the database 24 to store the provided information using patient and clinician identification numbers. The server 20 then notifies both the prescribing clinician and the primary clinician computer 32 of the delivered prescription and of any over-the-counter medication picked up by the patient or delivered to the patient. In an alternative embodiment the patient may use an application or app on a computer or mobile device to place the order for medications.

If the medication was filled but not picked-up by the patient or delivered to the patient within a predetermined number of days, the server 20 reports this fact to the prescribing physician and the primary physician associated with the patient ID number. The server notifies the registered patient's computer via email, as well as sends a SMS text and voice message to the registered patient's cellular telephone reminding them of an abandoned prescription.

The system can also be used to provide information to the clinician. For example if the enrolled clinician wants to prescribe a given medication for the patient but has questions about medications (for example about generics, dosage, or drug-drug interactions, etc) the clinician may telephone the pharmacy using a “Back-Line” feature or may email the designated pharmacy for a pharmacist to respond. Following clarification from the pharmacy, the clinician can then write or transmit a prescription for the patient to the pharmacy computer 40.

The registration/loyalty card may also be used to order additional medications, such as over-the-counter medicines, while at the clinician's office through the clinician's computer 32 or dedicated touchpad. Once the identity of the user is provided, the patient can order other medications and items for purchase while the clinician's prescribed medication is also ordered. The patient can then direct the order to a specified enrolled pharmacy and pick-up the medicines and other store items in a single order or have such items and medications delivered.

Finally, the patient can access the server 20, using his or her registration/loyalty number and password, review his or her own medication history and information and if desired request additional information of the pharmacy such as:

View and print a patient-specific personalized pharmacy medication chart: with an up-to-date medication list, name of medicine, type of medicine, route of administration, if pill or tablet—the color and shape of pill, prescribing clinician, date, precautions (do not take with . . . ) as well as a separate list of over-the-counter medications, supplements and vitamins typically used by the patient.

Request a personalized pharmacy medication therapy management consultation. A human system representative will arrange for the consultation with the pharmacist and coordinate with the primary enrolled clinician.

Contact an online “virtual” pharmacist who can answer questions and issues 24/7/365 who is a registered pharmacist.

Contact technology support staff with questions regarding technology-related issues.

Contact a human system representative for service-related issues

Thus, the present system not only makes the dispensing of medicine more effective, efficient and safer but provides support to patients by answering patient related questions.

While the present invention has been described in terms of certain exemplary preferred embodiments, it will be readily understood and appreciated by one of ordinary skill in the art that it is not so limited, and that many additions, deletions and modifications to the preferred embodiments may be made within the scope of the invention as hereinafter claimed. Accordingly, the scope of the invention is limited only by the scope of the appended claims.

1. A medical information system comprising:
a pharmacy computer processing prescriptions for a pharmacy;
a clinician computer for issuing, from a clinician, a prescription, for a patient, to a pharmacy computer; and
a server having a database, the server in communication with the clinician computer and the pharmacy computer;
wherein the pharmacy issues a medication for the patient in response to the prescription received by the pharmacy and issues a notice of prescription fulfillment to the server; and
wherein the server notifies the clinician computer if the medication has been picked up, delivered, abandoned by the patient or not renewed by the patient.

2. The system of claim 1 further comprising a patient computer in communication with the server.

3. The system of claim 2 wherein the patient computer is a mobile device.

4. The system of claim 1 further comprising a registration/loyalty card issued by the system and assigned to the patient and having a unique registration number.

5. The system of claim 4 wherein the database associates the clinician with the patient registration number.

6. The system of claim 5 wherein the database associates the pharmacy with the patient registration number.

7. The system of claim 2 wherein the patient using the patient computer may access the database for the patient's medication record.

8. The system of claim 2 wherein the server sends a reminder of abandoned or non-renewed prescriptions to the patient computer.

9. The system of claim 8 wherein the server sends SMS text and voice message to the patient's cellular telephone.

10. The system of claim 2 wherein the patient may make a request of a human representative for the system using the patient computer.

11. The system of claim 10 wherein the patient computer is a mobile device.

12. A method of using a medical information system comprising:
issuing, by a clinician, a prescription for a patient;
processing by a pharmacy computer at a pharmacy the prescription for the patient;
issuing by the pharmacy computer, to a server, a notice that the prescription is available for the patient and that the prescription picked up or delivered; and
receiving the notice of prescription fulfillment by the server having a database;
storing the prescription information in the database, and
notifying the clinician computer if the medication has been picked up, delivered or abandoned by the patient or not renewed by the patient.

13. The method of claim 12 further issuing a registration/loyalty card by the system and assigning it to the patient.

14. The method of claim 13 further comprising associating the clinician with the patient in the database using the registration card having a unique registration number.

15. The method of claim 13 further comprising associating the pharmacy with the patient in the database using the registration card number.

16. The method of claim 12 further comprising accessing the database for the patient's medication record using a patient computer.

17. The method of claim 16 wherein the patient computer is a mobile device.

18. The method of claim 12 further comprising sending a reminder of abandoned or non-renewed prescriptions to the patient computer by the server.

19. The method of claim 12 further comprising making a request of a human representative for the system using the patient computer.

20. The method of claim 19 wherein the patient computer is a mobile device.
